(19) United States
(12) Patent Application Publication
(10) Pub. No.: US 2015/0054846 A1
(43) Pub. Date: Feb. 26, 2015

(54) MOBILE ELECTRONIC DEVICE WITH ORIENTATION DEPENDENT AMBIENT LIGHT SENSITIVITY

(71) Applicant: LENOVO (SINGAPORE) PTE, LTD, New Tech Park (SG)

(72) Inventors: Mamoru Okada, Kanagawa-Ken (JP); Kazuhir Kosugi, Kanagawa-ken (JP)

(73) Assignee: LENOVO (SINGAPORE) PTE, LTD, New Tech Park (SG)

(21) Appl. No.: 13/973,715

(22) Filed: Aug. 22, 2013

(51) Int. Cl. G09G 5/10

(52) U.S. Cl. CPC G09G 5/10
USPC 345/589

(57) ABSTRACT

An electronic mobile device with a display may include brightness controls that may be adjusted upon detection in change of orientation of the device. An orientation sensor may be coupled to a processor. The processor, in response to a change in orientation, may determine if the device is oriented such that an ambient light sensor may be rotated. Ambient light sensitivity levels may be adjusted to account for the position of the ambient light sensor in a rotated orientation.

### BACKGROUND OF THE INVENTION

The present invention relates generally to electronic devices, and more particularly, to a mobile electronic device with orientation dependent light sensitivity.

Some mobile electronic devices may include features for adjusting display brightness. In some devices, an ambient light sensor may be positioned somewhere along a perimeter of the display to detect the ambient lighting incident on the display. The ambient light sensor may typically be configured to purely detect light and the internal mechanisms of the device may rely solely on the ambient light sensor for automatic control of display brightness. Thus, other factors affecting the device may be unaccounted.

Therefore, it can be seen that there is a need for an electronic device that may detect other conditions affecting control of display brightness.

### SUMMARY

In one aspect, an electronic device comprises: a display; and a processor configured to detect an orientation of the display, wherein the processor is configured to adjust brightness of the display from a first setting level to a second setting level in response to the orientation of the display being rotated from a default use position.

In another aspect, an electronic mobile device comprises: a display; an ambient light sensor coupled to the display configured to detect ambient light; a processor coupled to the ambient light sensor; and a gravity sensor coupled to the processor configured to detect a change in an orientation of the display from a default position to a rotated position, wherein the processor is configured to control brightness in the display in response to the gravity sensor detecting the display in the rotated position.

In a further aspect, a method of controlling brightness in a display of an electronic device comprises: detecting a change in an orientation position of the electronic device; determining the orientation position of the electronic device; determining a current ambient light sensitivity level setting in the electronic mobile device corresponding to the orientation position; determining whether the current ambient light sensitivity level setting corresponds to a default ambient light sensitivity level; and adjusting the current ambient light sensitivity level in response to the current ambient light sensitivity level setting not corresponding to the default ambient light sensitivity level.

These and other features, aspects and advantages of the present invention will become better understood with reference to the following drawings, description and claims.

### BRIEF DESCRIPTION OF THE DRAWINGS

FIGS. 1A and 1B are a front view of an electronic mobile device in a default orientation and a turned orientation in accordance with an exemplary embodiment of the present invention;

FIG. 2 is a block diagram of a control system in accordance with an exemplary embodiment of the present invention;

FIG. 3 is a flowchart of a method for changing light settings in accordance with an exemplary embodiment of the present invention;

FIG. 4A is a flowchart of a method of continuously checking light settings in accordance with an exemplary embodiment of the present invention;

FIG. 4B is a flowchart of a method of periodically adjusting light settings in accordance with an exemplary embodiment of the present invention; and

FIG. 5 is a chart showing changes to sensitivity levels in detecting ambient lighting dependent on orientation of the electronic device of FIGS. 1A and 1B.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments provide control over adjustment in display brightness of an electronic device depending on the orientation of the device. More particularly, in an exemplary embodiment, the sensitivity level setting for detecting ambient light may be adjusted to account for orientations where an ambient light sensor may be temporarily obstructed from detecting ambient light.

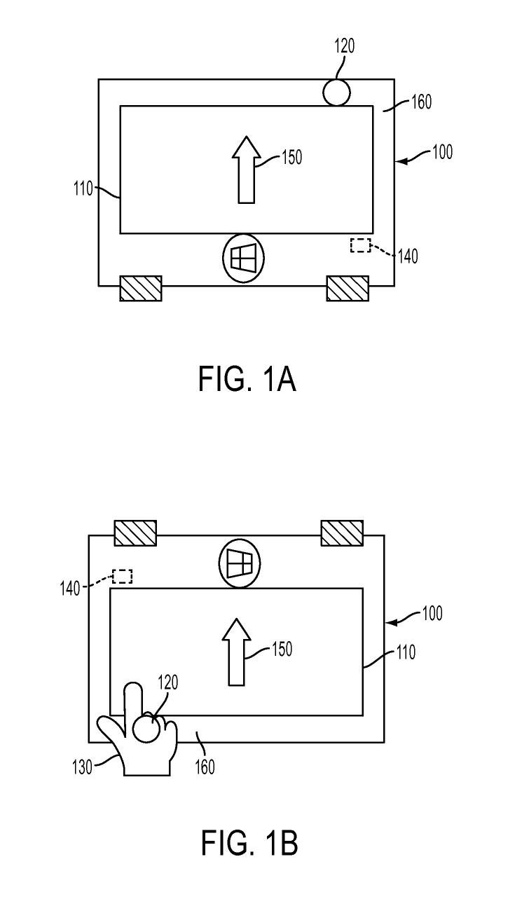

Referring now to FIGS. 1A and 1B, an electronic device 100 is shown according to an exemplary embodiment of the present invention. The electronic device 100 (referred to in general as the device 100) may be a mobile device or other computing capable device enabled to display an image 150. In an exemplary embodiment, the device 100 may include for example, a display 110, an ambient light sensor 120, and an orientation sensor 140. In an exemplary embodiment, the display 110 may be a touchscreen device configured to operate using tactile sensory.

The device 100 may adjust brightness of the image based on detected levels of ambient light detected by the ambient light sensor 120. An adjustment to brightness may depend on, for example, a threshold level of change in the ambient light. In some embodiments, the ambient light sensor 120 may be positioned on a display periphery 160. In some embodiments, the ambient light sensor 120 may be positioned on a same side as the display 110. In a default use position of the device 100 (FIG. 1A), the ambient light sensor 120 may be unobstructed to detect ambient light. However, when the device 100 is rotated (FIG. 1B), the ambient light sensor 120 may be intermittently obstructed by a user's hand 130, such as by holding the device 100 in the area of the ambient light sensor 120 or by the hand 130 moving in and out over the display 110. As may be understood, the hand 130 may cause unintended adjustment of brightness levels in this position.

The device 100 may be configured to maintain the orientation of the image 150 (relative to gravity) as the display 110 is rotated by a user. As shown in FIG. 1B, the device 100 may be rotated, for example 180 degrees from a default position during use with the image 150 maintaining its orientation. In an exemplary embodiment of the present invention, the device 100 may be configured to detect a change in the display's (110) orientation and may control adjustment of ambient light detection according to the position of the ambient light sensor 120 relative to the default use position. For example, the orientation sensor 140 may be a gravity sensor configured to detect a gravity vector and the position of the device 100 relative to the gravity vector. Details of adjustment control will be described in the following.

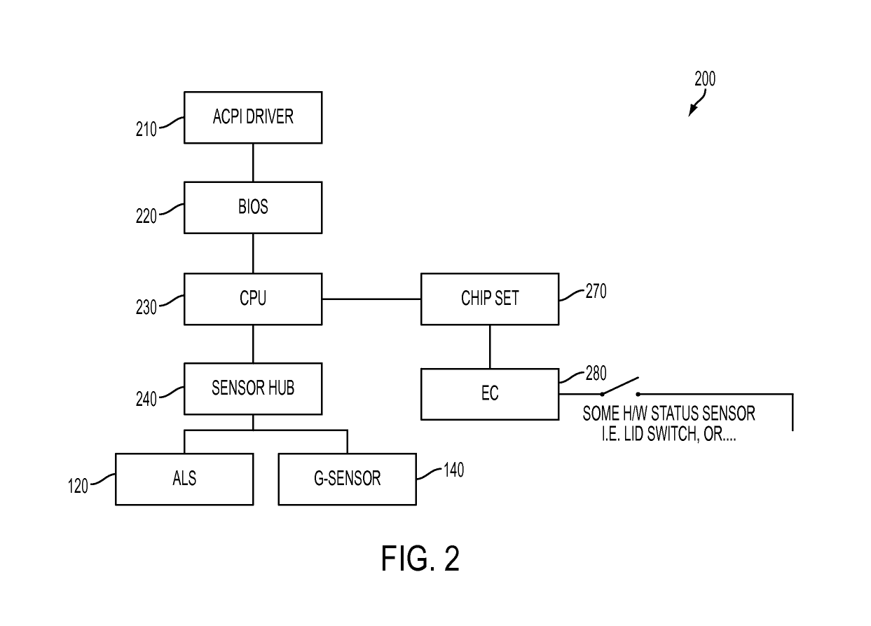

Referring now to FIG. 2 with concurrent reference to elements of FIGS. 1A and 1B, a control system 200 is shown according to an exemplary embodiment of the present invention. The control system 200 may be used to control the display 110. For example, the orientation and brightness of image 150 may be controlled according to instructions stored in the system 200. The system 200 may include for example, an advanced configuration and power interface (ACPI) module 210, a BIOS 220, a processor 230, a sensor hub 240, a chip set 270, and an electronic circuit 280. The sensor hub 240 may include the ambient light sensor 120 and the orientation sensor 140. The instructions may be stored for example, in the ACPI driver 210 and in the processor 230.

The processor 230 may be configured to process data provided by the ambient light sensor 120 and the orientation sensor 140. The processor 230 may use the data to change orientation of the image 150, detect changes in the orientation of the display 110, and adjust brightness levels of the display 110 based on the orientation of the device 100. The processor 230 may control brightness by adjusting sensitivity levels of ambient light detection.

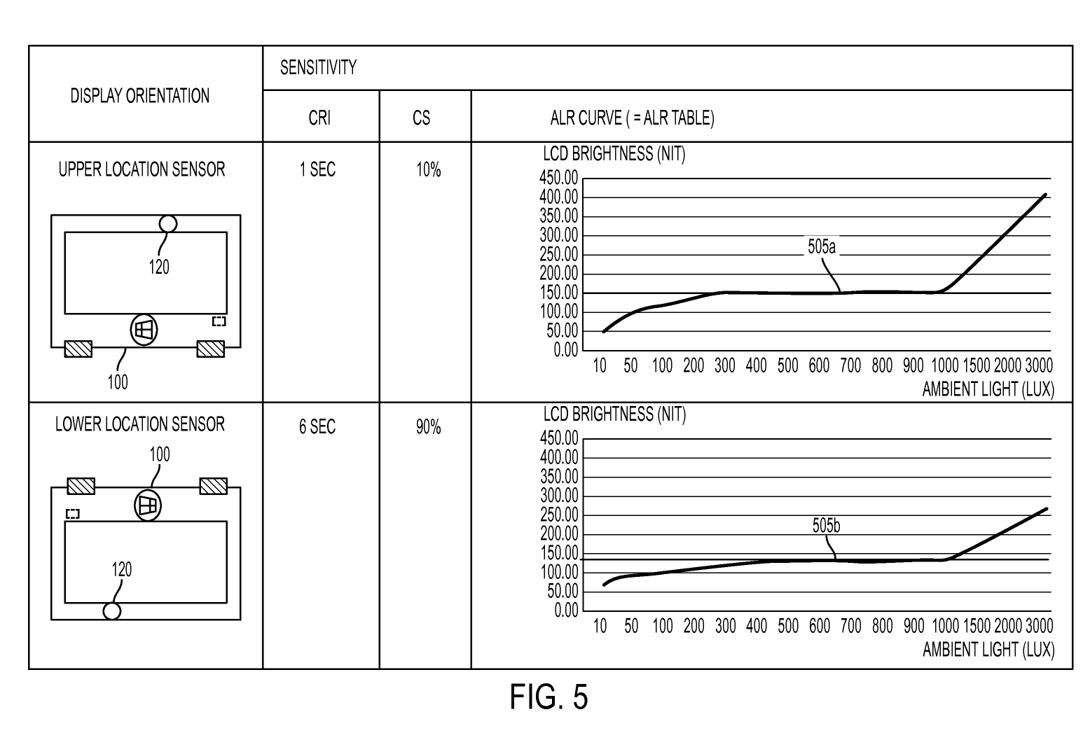

Referring to FIGS. 1, 2 and 5, in an exemplary embodiment, a different set of sensitivity settings may be used by the processor 230 to adjust brightness depending on the device 100 being oriented in the default use position or in a rotated position. The sensitivity levels may correspond to a change response interval (CRI), an illuminance change sensitivity (CS), and/or an ambient light response (ALR). The CR may refer to the frequency of checking for ambient light changes (expressed for example, in seconds). The CS may refer to a difference in light levels between measurements (expressed for example, as a percentage change). The ALR may represent data that correlates the brightness of the display 110 to the amount of ambient light detected. Exemplary settings for use dependent on the orientation of the display 110 may be seen in FIG. 5.

In an exemplary embodiment, the default use position (represented by the ambient light sensor 120 being positioned in the upper right portion of the device 100) may control brightness using sensitivity settings with a CRI of 1 second, a CS of 10% change, and the ALR curve 505a. In an exemplary embodiment, the rotated use position (represented by the ambient light sensor 120 being positioned in the lower left portion of the device 100) may control brightness using sensitivity settings with a CRI of 6 seconds, a CS of 90% change, and the ALR curve 505b. The processor 230 may provide instructions to the ACPI driver 210 which may in turn control behavior of the display 110 based on the foregoing sensitivity settings.

In an exemplary embodiment, the ACPI driver 210 may be configured to provide a faster reaction time, lower sensitivity to change, and rapid brightness adjustment to changes in ambient light when the device 100 is in the default use position and a slower reaction time, higher sensitivity, and slower brightness adjustment when the device 100 is rotated into a position where the ambient light sensor 120 may be obstructed. The frequency of the ACPI driver 210 to acquire measurements from the ambient light sensor 120 may thus be in accordance with the sensitivity level settings. For example, in the default use position, the CR sensitivity level setting may be set to a 1 second frequency in checking for changes in ambient light levels. In a rotated position, the CR sensitivity level may be set slower to, for example, a 6 second frequency in checking for changes in ambient light levels. As may be appreciated, reducing the reaction time to changes in ambient light when the display 110 is rotated may account for the ambient light sensor 120 being blocked temporarily, for example by the hand 130. Thus, delaying measurement of ambient light may allow the hand 130 to move in and out of the ambient light sensor's view which may prevent unintended changes to display brightness. In addition, controlling the sensitivity to light change and referring to an adjusted ALR curve may provide brightness control when for the ambient light sensor 120 being obstructed by the hand 130. For example, when the hand 130 is over the ambient light sensor 120, ambient light may illuminate the ambient light sensor 120 from around or under the hand 130. Changes to ambient light may remain observable but light levels may be affected by the presence of the hand 130. Changes to ambient light levels may thus occur observably slower since the hand 130 may obscure the surrounding light. Thus, the adjustment to brightness may take into account obstructed measurements. Thus, brightness may be indirectly controlled by using the orientation sensor 140 to detect that the ambient light sensor may be positioned to detect false ambient light readings.

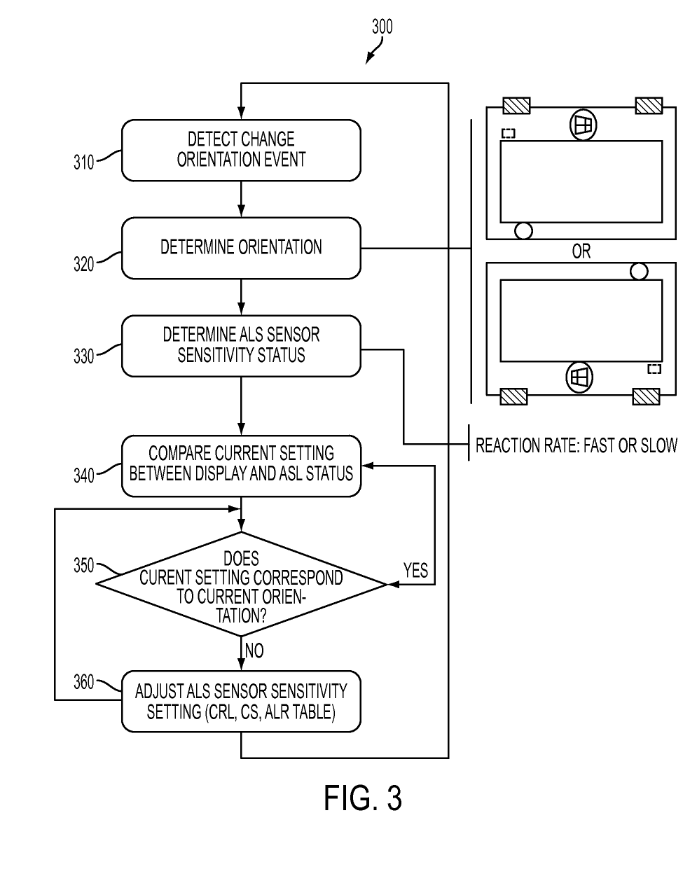

Referring to FIG. 3 a method 300 for changing light settings in the device 100 (FIG. 1) is shown according to an exemplary embodiment of the present invention. Reference will be made to elements of FIGS. 1A and 2 concurrently to the actions in the following steps. In block 310, the processor 230 may detect a change in orientation of the device 100 from data provided by the orientation sensor 140. In block 320, the processor 230 may determine the orientation of the display 110 relative to gravity based on the information from the orientation sensor 140. In block 330, the processor 230 may determine the current ambient light sensor 120 sensitivity level settings. If the device 100 is in the default use position, the sensitivity settings may be set to predetermined levels as described above. In block 340, the processor may determine if the current sensitivity settings correspond to the current orientation of the device 100. In block 350, if the ambient light sensor 120 sensitivity is appropriately set, then the method returns to block 310 where it may wait until a subsequent orientation change event occurs. If the ambient light sensor 120 sensitivity settings do not correspond to the current device 100 orientation then in block 360, the processor 230 may adjust the sensitivity settings in the ACPI driver 210. For example, if the device 100 was rotated from the default position to the rotated position and the sensitivity level was set for the default position, then the processor 230 may lower the frequency in checking for ambient light changes, raise the sensitivity to ambient light change, and/or switch to a different ALR curve.

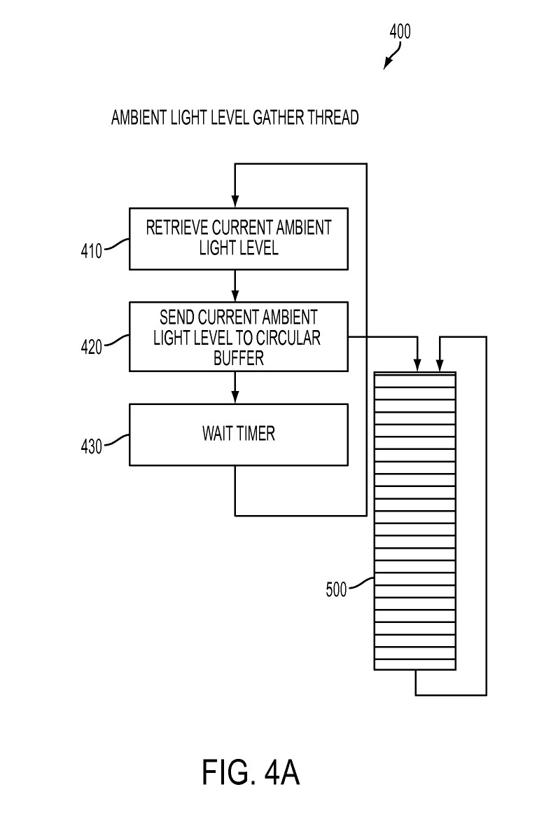

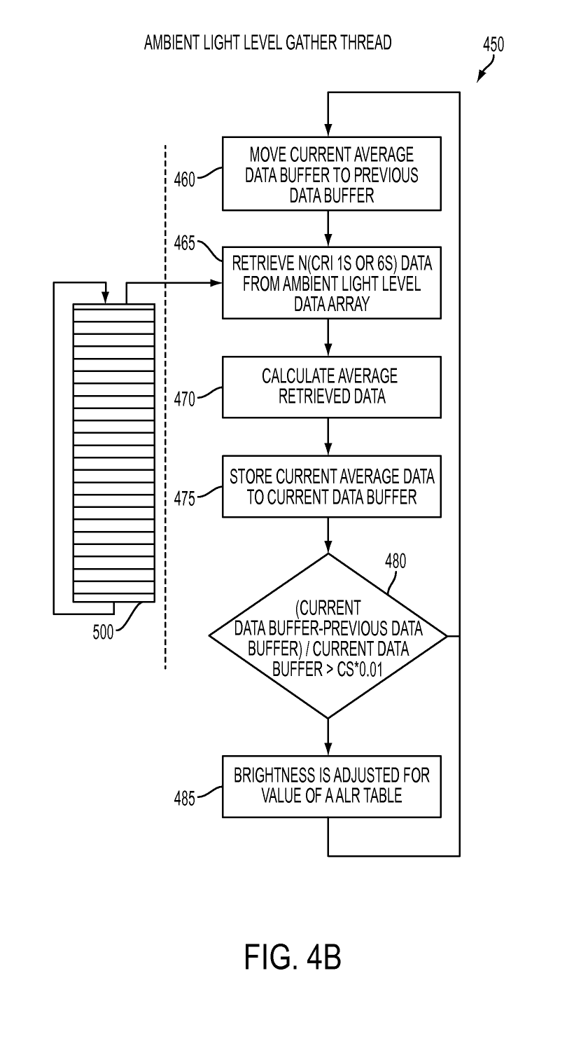

Referring now to FIGS. 4A and 4B, a method 400 of continuously checking light settings and a method 450 of periodically adjusting light settings is shown according to exemplary embodiments of the present invention. Reference will be made to elements of FIGS. 1A and 2 concurrently to the actions in the following steps. Methods 400 and 450 are shown in juxtaposition to show the use of a common data buffer 500.

Referring to FIG. 4A, the method 400 may continuously gather ambient light sensor 120 data for storage. In block 410, the processor 230 may retrieve current ambient light levels from the ambient light sensor 120. In block 420, the processor 230 may store the current light level reading to a buffer 500. The buffer 500 may be filled with data continuously on local storage area. In block 430, the processor 230 may wait before retrieving the next ambient light level in step 410.

Referring now to FIG. 4B, the method 450 may use the stored data in the buffer 500 to determine when a change in ambient light levels may trigger adjustment of brightness in the display 110. The method 450 may average out the data stored in the buffer 500. In block 460, the processor 230 may shift previously averaged data to another data buffer (not shown). In block 465, the processor 230 may retrieve the data in buffer 500 periodically based on the sensitivity settings (for example, either every 1 second or every 6 seconds depending on the detected orientation of the device 100). In block 470, the retrieved data may be averaged. In block 475, the processor 230 may store the current data average to a current buffer (not shown). In block 480, the processor 230 may determine if a predetermined change in ambient light levels has occurred to adjust brightness. For example, the processor 230 may determine the difference between the value of the previously averaged data and the currently averaged data. The processor 230 may determine if the difference is greater than a threshold illuminance change sensitivity level corresponding to the currently detected orientation of the device 100. In block 485, the processor 230 may adjust the brightness level of the display 110 when the difference in illuminance change sensitivity level is met. The brightness level may be adjusted according to the ALR curve corresponding to the currently detected orientation of the device 100.

It should be understood, of course, that the foregoing relate to exemplary embodiments of the invention and that modifications may be made without departing from the spirit and scope of the invention as set forth in the following claims.

We claim:

1. An electronic device, comprising:
a display; and
a processor configured to detect an orientation of the display, wherein the processor is configured to adjust brightness of the display from a first setting level to a second setting level in response to the orientation of the display being rotated from a default use position.

2. The electronic device of claim 1, further comprising an ambient light detector in communication with the processor configured to provide ambient light signals to the processor.

3. The electronic device of claim 2, wherein the processor is configured to control a sensitivity detection level corresponding to the ambient light sensor based on the detected orientation of the display.

4. The electronic device of claim 2, wherein the ambient light sensor is positioned on a same side of the electronic device as the display.

5. The electronic device of claim 3, wherein the processor is configured to lower a frequency of ambient light detection in the sensitivity detection level in response to the orientation of the display being rotated from the default orientation position.

6. The electronic device of claim 2, wherein the ambient light sensor is positioned on a periphery of the display.

7. The electronic device of claim 1, wherein the display is on a mobile device.

8. An electronic mobile device, comprising:
a display;
an ambient light sensor coupled to the display configured to detect ambient light;
a processor coupled to the ambient light sensor; and
a gravity sensor coupled to the processor configured to detect a change in an orientation of the display from a default position to a rotated position, wherein the processor is configured to control brightness in the display in response to the gravity sensor detecting the display in the rotated position.

9. The electronic mobile device of claim 8, wherein the rotated position is 180 degrees in rotation from the default position.

10. The electronic mobile device of claim 8, wherein the ambient light sensor is disposed to be obstructed by a user's hand in the rotated position.

11. The electronic mobile device of claim 8, wherein an adjustment of brightness is delayed in response to the display being detected in the rotated position.

12. The electronic mobile device of claim 8, wherein the processor is configured to adjust a change sensitivity setting level corresponding to the detected light in response to the display being in the rotated position.

13. The electronic mobile device of claim 8, wherein the processor is configured to switch from a first set of ambient light response data to a second set of ambient light response data in response to the display being in the rotated position.

14. A method of controlling brightness in a display of an electronic device, comprising:
detecting a change in an orientation position of the electronic device;
determining the orientation position of the electronic device;
determining a current ambient light sensitivity level setting in the electronic device corresponding to the orientation position;
determining whether the current ambient light sensitivity level setting corresponds to a default ambient light sensitivity level; and
adjusting the current ambient light sensitivity level in response to the current ambient light sensitivity level setting not corresponding to the default ambient light sensitivity level.

15. The method of claim 14, wherein the current ambient light sensitivity level and the default ambient light sensitivity level control a reaction time in detecting ambient luminance incident on the electronic device.

16. The method of claim 15, wherein the adjustment of the current ambient light sensitivity level increases the time delay in detecting ambient luminance.

17. The method of claim 14, further comprising:
adjusting an ambient light change sensitivity setting from a lower change value to a higher change value; and
adjusting the brightness in the display based on a difference between a current ambient light value with a previously detected ambient light value exceeding the higher change value.

18. The method of claim 14, further comprising:
using a first set of ambient light response data to control the brightness with the display in a default use position; and
using a second set of ambient light response data to control the brightness with the display in a rotated position.
